(19) United States
(12) Patent Application Publication
(10) Pub. No.: US 2026/0101080 A1
(43) Pub. Date: Apr. 9, 2026

(54) TV, AND METHOD FOR CONTROLLING TV

(71) Applicant: LG ELECTRONICS INC., Seoul (KR)

(72) Inventor: Jaesung LEE, Seoul (KR)

(73) Assignee: LG ELECTRONICS INC., Seoul (KR)

(21) Appl. No.: 19/104,030

(22) PCT Filed: Aug. 12, 2023
(86) PCT No.: PCT/KR2022/012324

§ 371 Date: Feb. 14, 2025

(51) Int. Cl. H04N 21/422; H04N 21/41

(52) U.S. Cl. CPC H04N 21/4221; H04N 21/4104

(57) ABSTRACT

One embodiment of the present invention provides a method for controlling a TV, the method being characterized by comprising the steps of: receiving information about a remote control device and information about an external device from the remote control device through UWB communication; calculating the relative distance and angle of the external device on the basis of the information about the remote control device and the information about the external device; performing Bluetooth pairing with the external device on the basis of the relative distance and angle of the external device; executing a surround sound mode providing surround sound; and automatically setting the volume of the external device on the basis of the relative distance and angle of the external device.

### TECHNICAL FIELD

The present disclosure relates to a TV and a method of controlling the TV.

### BACKGROUND ART

With development of the information society, demand for TVs has been increasing in various forms, and in response thereto, in recent years, liquid crystal displays (LCDs), field emission displays (FEDs), plasma display panels (PDPs), electroluminescent devices, etc. have been used as the TVs.

A liquid crystal panel of a liquid crystal display device includes a liquid crystal layer and a TFT substrate and a color filter substrate facing each other with the liquid crystal layer interposed therebetween, and may display an image using light provided from a backlight unit.

As an example of an electroluminescent device, an active matrix type organic light-emitting display is commercially available. The organic light-emitting display is a self-luminous device, and thus has advantages over a liquid crystal display in terms of response speed, viewing angle, etc., without a backlight, and is attracting attention as a next-generation display.

In order to connect such a TV to a Bluetooth device, a pairing mode needs to be set by checking a user manual of the Bluetooth device. Thereafter, a Bluetooth connection menu needs to be found on a master device (for example, the TV) to be connected to the Bluetooth device. Finally, a user needs to search for a device to be connected in the menu and press a connection button. In this instance, when the master device does not have a display, the Bluetooth connection or search menu cannot be displayed, making a Bluetooth connection process significantly difficult.

In other words, when connecting wireless devices such as Bluetooth devices, there are many cases where a connection method is difficult for general users, and thus technology is required to provide easy and convenient wireless connection.

To satisfy these requirements, conventional art (Publication No. 10-2018-0068823) discloses technology for correcting a position of a pedestrian by acquiring a plurality of pieces of estimated data related to movement of the pedestrian including a plurality of IMUs (Inertial Measurement Units) through a navigation system using indoor position tracking using multiple sensors. However, the above problem cannot be solved only by correcting the pedestrian position using the IMU.

### DISCLOSURE

### Technical Task

An object of the present disclosure is to provide a TV and a method of controlling the TV to solve the above-mentioned problem.

### Technical Solutions

An embodiment of the present disclosure provides a TV including a network interface unit configured to receive information about an external device through UWB communication from a remote controller, a display configured to output content, and a controller configured to control the network interface unit and the display, wherein the controller is configured to calculate a relative distance and angle of the external device based on information about the remote controller and the information about the external device, and perform Bluetooth pairing with the external device based on the relative distance and angle of the external device.

The controller may be configured to execute a surround sound mode providing surround sound, and automatically set a volume of the external device based on the relative distance and angle of the external device.

The controller may output a sound effect through the external device based on the relative distance and angle of the external device in the surround sound mode.

The information about the external device may include a Bluetooth address of the external device, and the controller may execute the Bluetooth pairing based on the Bluetooth address in response to receiving a control signal from the remote controller.

The information about the external device may include a distance from the remote controller to the external device and an angle between the external device and the TV with respect to the remote controller.

The controller may be configured to perform Bluetooth communication from the remote controller to create a UWB session for the UWB communication with the remote controller, and transmit information indicating that the TV is a device supporting the UWB communication through the Bluetooth communication.

When the remote controller is a mobile device, the mobile device may be approved for creation of the UWB session through a display module.

When the remote controller is a remote control, the remote control may be approved for creation of the UWB session through a specific key, and the specific key may include a physical key or a virtual key included in the remote controller.

The remote controller may request power-on of the external device through the UWB communication from the external device.

The remote controller may request setup for the Bluetooth pairing through the UWB communication from the external device.

An embodiment of the present disclosure provides a remote controller including a housing, a UWB module configured to perform UWB communication, and a controller, wherein the controller is configured to calculate a distance to a master device and a distance to a slave device through the UWB communication, calculate an angle between the master device and the slave device with respect to the remote controller, and transmit the distances and the angle to the master device.

The remote controller may further include at least one physical key included in the housing, wherein, in response to receiving a control signal representing selecting of the physical key, the controller may request Bluetooth pairing setup from the slave device and transmit a Bluetooth address of the slave device to the master device.

The remote controller may further include a display module, wherein, when a distance to the slave device is less than or equal to a first distance or the remote controller is facing the slave device, the controller may output a modal dialog box, and the modal dialog box may include information indicating whether Bluetooth pairing is performed between the master device and the slave device.

In response to receiving a control signal representing selecting of a button included in the modal dialog box, the controller may request Bluetooth pairing setup from the slave device and transmit a Bluetooth address of the slave device to the master device.

The controller may be configured to output a location map indicating a relative distance between the master device and the slave device through the display module, and request Bluetooth pairing setup from the slave device and transmit a Bluetooth address of the slave device to the master device in response to receiving a control signal representing selecting of an icon corresponding to the slave device included in the location map.

An embodiment of the present disclosure provides a method of controlling a TV, the method including receiving information about a remote controller and information about an external device through UWB communication from the remote controller, calculating a relative distance and angle of the external device based on the information about the remote controller and the information about the external device, performing Bluetooth pairing with the external device based on a relative distance and angle of the external device, executing a surround sound mode that provides surround sound, and automatically setting volume of the external device based on the relative distance and angle of external device.

### Advantageous Effects

According to an embodiment of the present disclosure, there is an advantage in that wireless connection between devices is enabled through simple operation, thereby easily and quickly performing wireless connection.

Effects that may be obtained from the present disclosure are not limited to the effects mentioned above, and other effects not mentioned are able to be clearly understood by those skilled in the art in the technical field to which the present disclosure belongs from a description below.

### DESCRIPTION OF DRAWINGS

FIG. 1 is a block diagram illustrating constituent elements of a TV according to an embodiment of the present disclosure.

FIG. 2 is a diagram describing a method of connecting a master device and a slave device according to an embodiment of the present disclosure.

FIG. 3A and FIG. 3B are diagrams describing an embodiment in which a remote controller measures a position of a device according to an embodiment of the present disclosure.

FIG. 4 is a diagram describing an embodiment in which the remote controller establishes a UWB session with a device according to an embodiment of the present disclosure.

FIG. 5A and FIG. 5B are diagrams describing an embodiment in which the master device pairs with the slave device using a remote control according to an embodiment of the present disclosure.

FIG. 6A and FIG. 6B are diagrams describing an embodiment in which the master device pairs with the slave device using a mobile device according to an embodiment of the present disclosure.

FIG. 7 is a diagram describing an embodiment in which the master device controls the slave device according to an embodiment of the present disclosure.

FIG. 8 is a diagram describing a method of controlling the TV according to an embodiment of the present disclosure.

### BEST MODE FOR DISCLOSURE

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be directly connected with the other element or intervening elements may also be present. In contrast, when an element is referred to as being “directly connected with” another element, there are no intervening elements present.

A singular representation may include a plural representation unless it represents a definitely different meaning from the context.

Terms such as “include” or “has” are used herein and should be understood that they are intended to indicate an existence of several components, functions or steps, disclosed in the specification, and it is also understood that greater or fewer components, functions, or steps may likewise be utilized.

On the other hand, the TV described herein is, for example, an intelligent image display device implemented by adding a computer support function to a broadcast reception function, and further includes an Internet function or the like while sufficiently performing the broadcast reception function, so that the image display device may have user-friendly interfaces such as a handwriting input device, a touchscreen, or a spatial remote control. Further, the image display device can support a wired or wireless Internet function by connecting to the Internet and a computer device, thereby performing e-mailing, web browsing, banking, or gaming. To implement these functions, the image display device may operate based on a standard general-purpose Operating System (OS).

Accordingly, the TV according to the present disclosure is designed in a manner that various applications can be easily added to or deleted from a general-purpose OS kernel so that the image display device can perform various user-friendly functions. The image display device may be, for example, a network TV, a Hybrid broadcast broadband TV (HBBTV), a smart TV, etc. The image display device is applicable to a smartphone as needed.

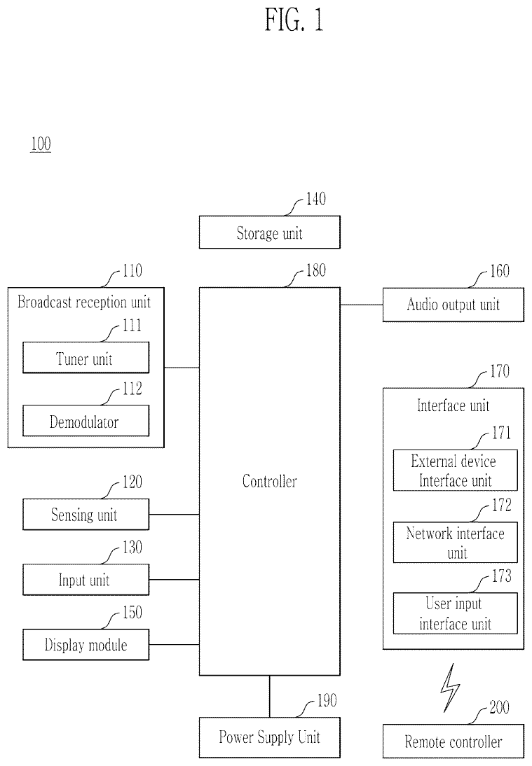

FIG. 1 is a block diagram illustrating constituent elements of a TV 100 according to an embodiment of the present disclosure.

Referring to FIG. 1, the TV 100 may include a broadcast reception unit 110, an external device interface unit 171, a network interface unit 172, a storage unit 140, a user input interface unit 173, an input unit 130, a controller 180, a display 150, an audio output unit 160, and/or a power-supply unit 190.

The broadcast reception unit 110 may include a tuner unit 111 and a demodulator 112.

Although not shown in the drawings, the TV 100 may include only the external device interface unit 171 and the network interface unit 172 from among the broadcast reception unit 110, the external device interface unit 171, and the network interface unit 172. That is, the TV 100 may not include the broadcast reception unit 110.

The tuner unit 111 may select a broadcast signal corresponding to either a user-selected channel or all prestored channels from among broadcast signals received through an antenna (not shown) or a cable (not shown). The tuner unit 111 may convert the selected broadcast signal into an intermediate frequency (IF) signal or a baseband image or a voice signal.

For example, when the selected broadcast signal is a digital broadcast signal, the tuner unit 111 may convert the selected broadcast signal into a digital IF (DIF) signal. When the selected broadcast signal is an analog broadcast signal, the tuner unit 111 may convert the selected broadcast signal into an analog baseband image or a voice signal (CVBS/SIF). That is, the tuner unit 111 may process the digital broadcast signal or the analog broadcast signal. The analog baseband image or the voice signal (CVBS/SIF) output from the tuner unit 111 may be directly input to the controller 180.

The tuner unit 111 may sequentially select broadcasting signals of all broadcasting channels stored through a channel memory function from among the received broadcast signals, and may convert the selected broadcast signal into an intermediate frequency (IF) signal or a baseband image or a voice signal.

The tuner unit 111 may include a plurality of tuners to receive broadcast signals of the plurality of channels. Alternatively, a single tuner for simultaneously receiving broadcast signals of the plurality of channels is also possible.

The demodulator 112 may receive the digital IF signal (DIF) converted by the tuner unit 111, and may thus perform demodulation of the received signal. The demodulator 112 may perform demodulation and channel decoding, and may output a stream signal (TS). The stream signal may be a signal formed by multiplexing an image signal, a voice signal, or a data signal.

The stream signal (TS) output from the demodulator 112 may be input to the controller 180. The controller 180 may perform demultiplexing, image/audio signal processing, etc., may output an image through the display 150, and may output a voice through the audio output unit 160.

The sensing unit 120 may sense a change in the TV 100 or may sense an external change. For example, the sensing unit 120 may include a proximity sensor, an illumination sensor, a touch sensor, an infrared (IR) sensor, an ultrasonic sensor, an optical sensor (e.g., a camera), a voice sensor (e.g., a microphone), a battery gauge, environmental sensors (e.g., hygrometer, a thermometer, etc.).

The controller 180 may check a state of the TV 100 based on information collected by the sensing unit 120, may notify the user of a problem, or may control the TV 100 to be kept in the best state.

In addition, it is possible to provide an optimal viewing environment by differently controlling the content, image quality, size, etc. of the image provided to the display module 180 depending on the viewer, ambient illuminance, etc. sensed by the sensing unit. As the smart TV has evolved, the number of functions mounted in the display device increases, and the number of the sensing units 20 also increases together with the increasing functions.

The input unit 130 may be provided at one side of a main body of the TV 100. For example, the input unit 130 may include a touch pad, a physical button, and the like. The input unit 130 may receive various user commands related to the operation of the TV 100, and may transmit a control signal corresponding to the input command to the controller 180.

Recently, as a bezel of the TV 100 decreases in size, the number of display devices 100 each including a minimum number of input unit 130 formed in a physical button exposed to the outside is rapidly increasing. Instead, a minimum number of physical buttons may be provided on the back or side surface of the TV 100. The display device may receive a user input through the remote controller 200 through a touchpad or a user input interface unit 173 to be described later.

The storage unit 140 may store a program for processing and controlling each signal used in the controller 180, and may store a signal-processed image, a voice, or a data signal. For example, the storage unit 140 may store application programs designed for the purpose of performing various tasks that can be processed by the controller 180, and may selectively provide some of the stored application programs upon request of the controller 180.

The program stored in the storage unit 140 is not specifically limited to being executed by the controller 180. The storage unit 140 may perform a function for temporarily storing an image, a voice, or a data signal received from an external device through the external device interface unit 171. The storage unit 140 may store information about a predetermined broadcast channel through a channel memory function such as a channel map.

Although the storage unit 140 of FIG. 1 is provided separately from the controller 180, the scope of the present disclosure is not limited thereto, and the storage unit 140 may also be included in the controller 180 as needed.

The storage unit 140 may include at least one of a volatile memory (e.g., DRAM, SRAM, SDRAM, etc.) and a non-volatile memory (e.g., flash memory, hard disk drive (HDD), solid state drive (SSD), etc.).

The display 150 may generate a drive signal by converting an image signal, a data signal, an OSD signal, a control signal processed by the controller 180, or by converting an image signal, a data signal, a control signal, etc. received from the interface unit 171. The display 150 may include a display panel 181 having a plurality of pixels.

A plurality of pixels included in the display panel may include RGB sub-pixels. Alternatively, a plurality of pixels included in the display panel may include sub-pixels of RGBW. The display 150 may convert the image signal, the data signal, the OSD signal, the control signal, etc. processed by the controller 180 to generate a drive signal for the plurality of pixels.

The display 150 may be implemented as a plasma display panel (PDP), a liquid crystal display (LCD), an organic light emitting diode (OLED), a flexible display, etc. In addition, the display 150 may also be implemented as a three-dimensional (3D) display. The three-dimensional (3D) display 150 may be classified into a glassless-type 3D display and a glasses-type 3D display.

The display device may include a display module that occupies most parts of the front surface, and a case that covers the back and side surfaces of the display module and packages the display module.

Recently, the TV 100 has evolved from a flat-screen display to a curved-screen display. In order to implement the curved screen, the TV 100 may use a display module 150 that can be bent or curved, such as a light emitting diode (LED) or an organic light emitting diode (OLED), etc.

Conventionally, the LCD has difficulty in self-emitting light, so that the conventional LCD has been designed to receive light through a backlight unit. The backlight unit is a device for uniformly supplying light received from a light source to a liquid crystal located on the front surface of the display device. As the backlight becomes thinner, a thin LCD can be implemented. However, it is actually difficult for the backlight unit to be implemented as a curved structure formed of a flexible material. Although the backlight unit is implemented as a curved shape, it is difficult for light to be uniformly applied to the liquid crystal, thereby changing brightness of the screen.

On the other hand, the LED or the OLED is designed in a manner that each of constituent elements constructing the pixels can self-emit light without using the backlight unit, so that the LED or the OLED can be implemented as a curved shape without any problems. In addition, since each element can perform self-emission of light, brightness of each element is not affected by a change in the positional relationship between the element and adjacent elements, so that a curved display module 150 can be implemented as an LED or OLED.

OLED (Organic Light Emitting Diode) panels appeared in earnest in mid-2010 and are rapidly replacing LCDs in the small-and medium-sized display market. The OLED is a display made using the self-emission characteristics in which OLED emits light when a current flows in a fluorescent organic compound. Since the response speed of the OLED is faster than that of the LCD, there is little afterimage when moving images are implemented.

OLEDs may be used as a light-emitting display product. In this case, the light-emitting display device may use three fluorescent organic compounds (such as red, green, and blue) each having a self-emitting function, and may use the self-emitting phenomenon in which positive(+)-charged particles and electrons injected from a cathode and anode are combined with each other within the organic material, so that a backlight unit causing degradation of color sense need not be used.

The LED panel is implemented by technology for using only one LED element as one pixel, and has a smaller LED element compared to the prior art, so that a curved display module 150 can be implemented. Whereas the conventional device referred to as an LED TV can use the LED as a light source of the backlight unit for supplying light to the LCD, it is impossible for the LED of the conventional device to constitute a screen.

The display module may include a display panel, a coupling magnet located on the rear surface of the display panel, a first power-supply unit, and a first signal module. The display panel may include a plurality of pixels (R, G, B). The plurality of pixels (R, G, B) may be formed in each region where a plurality of data lines and a plurality of gate lines cross each other. The plurality of pixels (R, G, B) may be arranged in a matrix.

For example, the plurality of pixels (R, G, B) may include a red(R) sub-pixel, a green(G) sub-pixel, and a blue(B) sub-pixel. The plurality of pixels (R, G, B) may further include white (W) sub-pixel(s).

In the display module 150, one side where an image is displayed may be referred to as a front side or a front surface. When the display module 150 displays an image, one side where no image is observed may be referred to as a rear side or a rear surface.

Meanwhile, the display 150 may be implemented as a touchscreen, so that the display 150 can also be used as an input device in addition to an output device.

The audio output unit 160 may receive a voice-processed signal from the controller 180, and may output the received signal as a voice signal.

The interface unit 170 may serve as a path of connection to various kinds of external devices connected to the TV 100. The interface unit may include not only a wired method for transmitting/receiving data through a cable, but also a wireless method using the antenna.

The interface unit 170 may include at least one of a wired/wireless headset port, an external charger port, a wired/wireless data port, a memory card port, a port connected to a device having an identification module, an audio input/output (I/O) port, a video I/O port, and an earphone port.

As an example of a wireless method, the above-described broadcast reception unit 110 may be used. The broadcast reception unit 110 may be configured to use a broadcast signal, a mobile communication short-range communication signal, a wireless Internet signal, and the like.

The external device interface unit 171 may transmit or receive data to and from a connected external device. To this end, the external device interface unit 171 may include an A/V input/output (I/O) unit (not shown).

The external device interface unit 171 may be wired or wirelessly connected to an external device such as a digital versatile disc (DVD) player, a Blu-ray player, a game console, a camera, a camcorder, a computer (laptop), a set-top box, or the like, and may perform an input/output (I/O) operation with the external device.

In addition, the external device interface unit 171 may establish a communication network with various remote controllers 200, may receive a control signal related to operation of the TV 100 from the remote controller 200, or may transmit data related to operation of the TV 100 to the remote controller 200.

The external device interface unit 171 may include a wireless communication unit (not shown) for short-range wireless communication with other electronic devices. Through the wireless communication unit (not shown), the external device interface unit 171 may exchange data with an adjacent mobile terminal. In particular, the external device interface unit 171 may receive device information, application information, an application image, and the like from the mobile terminal in a mirroring mode.

The network interface unit 172 may provide an interface for connecting the TV 100 to a wired/wireless network including the Internet network. For example, the network interface unit 172 may receive content or data provided by the Internet, a content provider, or a network administrator through a network. The network interface unit 172 may include a communication module (not shown) for connection with the wired/wireless network.

The external device interface unit 171 and/or the network interface unit 172 may include a communication module for short-range communication such as Wi-Fi, Bluetooth, Bluetooth low energy (BLE), ZigBee, Near Field Communication (NFC), and a communication module for cellular communication such as Long-Term Evolution (LTE), LTE-A (LTE Advanced), Code Division Multiple Access (CDMA), WCDMA (wideband CDMA), UMTS (universal mobile telecommunications system), WiBro (Wireless Broadband), etc.

The user input interface unit 173 may transmit user input signals to the controller 180, or may transmit signals received from the controller 180 to the user. For example, the user input interface unit 173 may transmit or receive user input signals (such as a power-on/off signal, a channel selection signal, and a screen setting signal) to and from the remote controller 200, may transmit user input signals received through a local key (not shown) such as a power key, a channel key, a volume key, and a setting key to the controller 180, may transmit a user input signal received by a sensor unit (not shown) for sensing a user gesture to the controller 180, or may transmit a signal received from the controller 180 to the sensor unit.

The controller 180 may include at least one processor, and may control the overall operation of the TV 100 using the processor included therein. Here, the processor may be a general processor such as a CPU. Of course, the processor may be a dedicated device such as an ASIC, or other hardware-based processor.

The controller 180 may demultiplex the stream received through the tuner unit 111, the demodulator 112, the external device interface unit 171, or the network interface 172, and may process the demultiplexed signals to generate and output a signal for image or voice output.

The image signal processed by the controller 180 may be input to the display 150 and displayed as an image corresponding to the corresponding image signal. In addition, the image signal processed by the controller 180 may be input to the external output device through the external device interface unit 171.

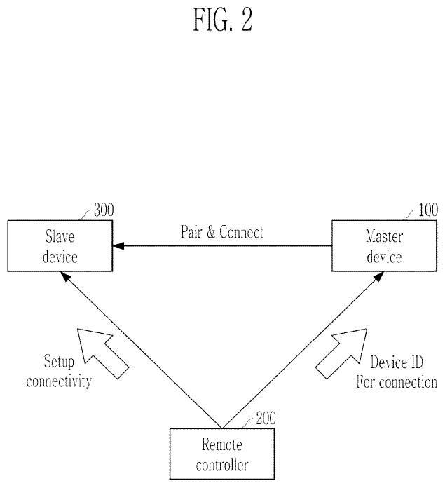

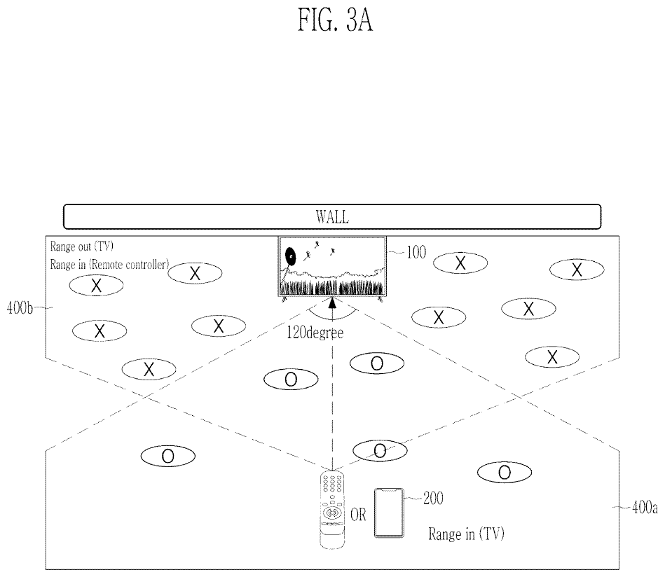

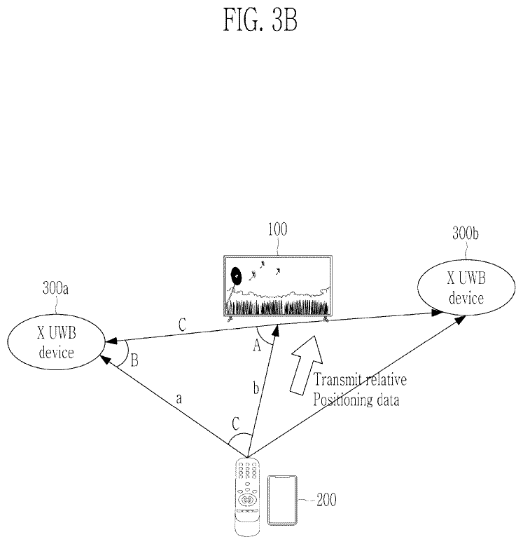

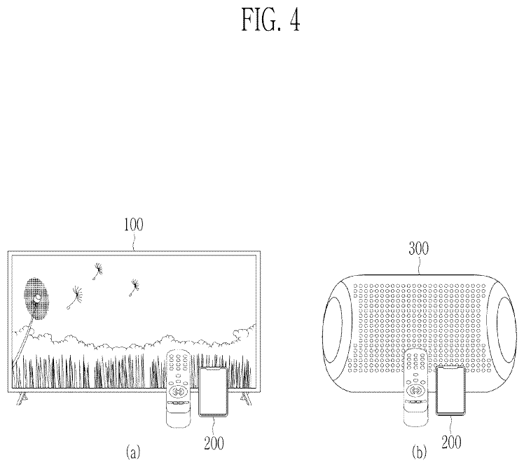

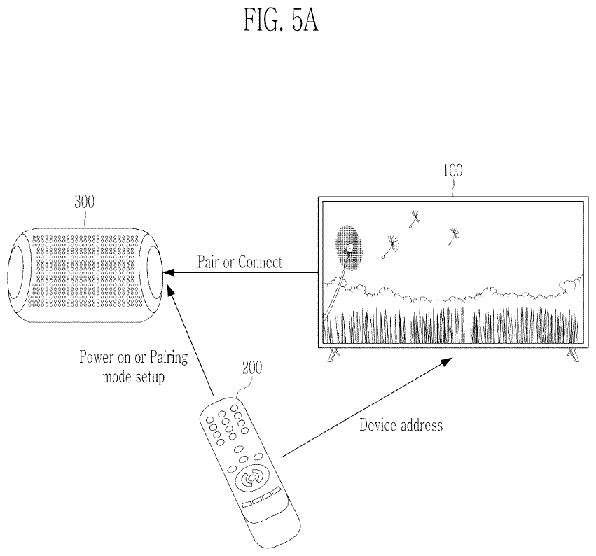

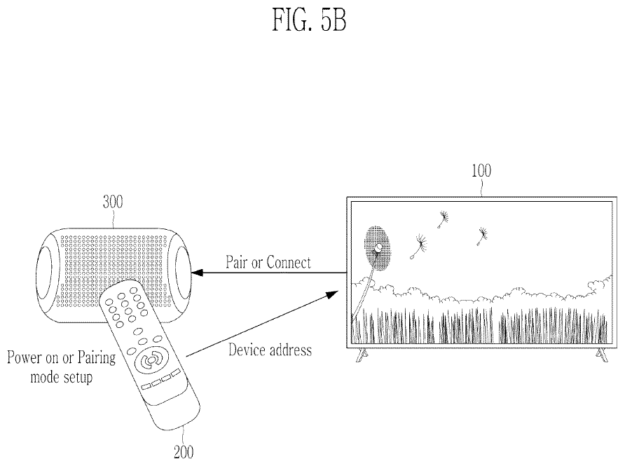

The voice (or audio) signal processed by the controller 180 may be audibly output to the audio output unit 160. In addition, the voice signal processed by the controller 180 may be input to the external output device through the external device interface unit 171. Although not shown in FIG. 2, the controller 180 may include a demultiplexer, an image processor, and the like, and a detailed description thereof will hereinafter be described with reference to FIG. 3.

In addition, the controller 180 may control the overall operation of the TV 100. For example, the controller 180 may control the tuner unit 111 to select a broadcast program corresponding to either a user-selected channel or a prestored channel.

In addition, the controller 180 may control the TV 100 by a user command or an internal program received through the user input interface unit 173. The controller 180 may control the display 150 to display an image. In this case, the image displayed on the display 150 may be a still image or a moving image, and may be a 2D image or a 3D image.

On the other hand, the controller 180 may display a predetermined 2D object in the image displayed on the display 150. For example, the object may be at least one of a connected web screen (newspaper, magazine, etc.), electronic program guide (EPG), various menus, widgets, icons, still images, moving images, and text.

Meanwhile, the controller 180 may modulate and/or demodulate the signal using an amplitude shift keying (ASK) scheme. Here, the ASK scheme may refer to a method for modulating a signal by differentiating the amplitude of a carrier wave according to data values or for restoring an analog signal to a digital data value according to the amplitude of the carrier wave.

For example, the controller 180 may modulate an image signal using the ASK scheme, and may transmit the modulated signal through a wireless communication module.

For example, the controller 180 may demodulate and process the image signal received through the wireless communication module using the ASK scheme.

Accordingly, the TV 100 may simply transmit and receive signals to and from other image display devices arranged adjacent to each other without using either a unique identifier such as a Media Access Control (MAC) address or a complex communication protocol such as TCP/IP.

On the other hand, the TV 100 may further include a photographing unit (not shown). The photographing unit may photograph a user. The photographing unit may be implemented as one camera, but is not limited thereto, and may be implemented by a plurality of cameras. On the other hand, the photographing unit may be embedded in the TV 100 or may be separately arranged on the display 150. The image information photographed by the photographing unit may be input to the controller 180.

The controller 180 may recognize the position of the user based on the image photographed by the photographing unit. For example, the controller 180 may recognize a distance (z-axis coordinates) between the user and the TV 100. In addition, the controller 180 may recognize the X-axis coordinate and the Y-axis coordinate within the display 150 corresponding to the user position.

The controller 180 may sense a user gesture based on an image photographed by the photographing unit, each of signals detected by the sensor unit, or a combination thereof.

The power-supply unit 190 may supply corresponding power to the TV 100. In particular, the controller 180 may be implemented as a System on Chip (SoC), a display 150 for displaying an image, and an audio output unit 160 for audio output.

Specifically, the power-supply unit 190 may include a converter (not shown) for converting AC power into DC power, and a DC/DC converter (not shown) for converting the level of DC power.

On the other hand, the power-supply unit 190 may receive power from the external power source, and may distribute the received power to the respective components. The power-supply unit 190 may be directly connected to the external power source to supply AC power, and may include a battery capable of being charged with electricity.

In the former case, the power-supply unit 190 may be used by connecting to a wired cable, and it is difficult for the power-supply unit 190 to move from one place to another place, and the movement range of the power-supply unit 190 is limited. In the latter case, the power-supply unit 190 can move from one place to another place, but the weight and volume of the power-supply unit 190 may increase as much as the weight and volume of the battery. In addition, for charging, the power-supply unit 190 should be directly connected to a power cable for a predetermined period of time or should be coupled to a charging cradle (not shown) for power supply.

The charging cradle may be connected to the display device through a terminal exposed to the outside. Alternatively, if the power-supply unit 190 approaches the charging cradle using a wireless interface, a built-in battery of the power-supply unit 190 may also be charged with electricity.

The remote controller 200 may transmit a user input to the user input interface unit 173. To this end, the remote controller 200 may use Bluetooth, Radio Frequency (RF) communication, infrared (IR) communication, Ultra-Wideband (UWB), ZigBee, or the like. In addition, the remote controller 200 may receive the image, voice, or data signal output from the user input interface unit 173, and may display or audibly output the received image, voice, or data signal.

On the other hand, the above-described TV 100 may be a fixed or mobile digital broadcast receiver capable of receiving digital broadcast signals.

Meanwhile, the block diagram of the TV 100 shown in FIG. 1 is disclosed for only for illustrative purposes for one embodiment of the present disclosure, and the respective components of the TV 100 shown in FIG. 1 can be integrated, added or omitted according to the specifications of the digital device 100 which is actually implemented.

That is, if necessary, two or more components may be combined into one component, or one component may be subdivided into two or more components. In addition, the functions performed in each block are intended to explain the embodiment of the present disclosure, and the specific operation or device does not limit the scope of the present disclosure.

An object of the present disclosure is to simplify a wireless communication connection process by incorporating UWB technology. In other words, the present disclosure aims to provide an easy connection method to various devices that require wireless connection, such as Bluetooth.

To this end, a UWB connection system including a master device, a slave device, and a controller will be introduced through FIGS. 2 to 8.

In particular, the master device includes the TV described in FIG. 1, and may include any device connectable through Bluetooth, such as a refrigerator or a washing machine without a display module. However, for convenience of description, the master device will be described using the TV 100 described in FIG. 1 as an example.

Likewise, the slave device may include any device connectable through Bluetooth, such as an IoT device or a Bluetooth speaker. However, for convenience of description, the slave device will be described using the Bluetooth speaker as an example.

In addition, the controller may include a mobile device or the remote controller 200 described above with reference to FIG. 1 as a remote controller for wireless connection between the master device and the slave device. This will be described in detail with reference to the drawings below.

In addition, it is assumed that the master device, the slave device, and the controller described below are all devices to which UWB is applied. Here, UWB is an abbreviation for Ultra Wide Band and is technology capable of measuring an exact position of a device. Previously, only an approximate distance to another device could be measured using Bluetooth. In other words, in the past, when Bluetooth technology was used, approximate and inaccurate distance measurements were possible in a Bluetooth advertising stage. However, when UWB technology is used, there is an advantage in that an exact direction and distance of a device may be accurately measured within an error range of 10 cm.

FIG. 2 is a diagram describing a method of connecting the master device and the slave device according to an embodiment of the present disclosure. A description overlapping with content described above will be omitted.

Referring to FIG. 2, the master device 100 may pair with a slave device 300 using the remote controller 200.

An embodiment of the present disclosure is characterized by applying UWB technology to the remote controller 200 to facilitate connection between the master device 100 and the slave device 300. That is, since a device to which UWB technology is applied may be used as the remote controller 200, the remote controller 200 may include a remote control or a mobile device to which UWB technology is applied. A reason therefor is that UWB technology is applied to mobile devices (for example, smartphones, tablet computers, etc.).

When the remote controller 200 measures a position, the master device 100 and the slave device 300 may respond to the remote controller 200 with position information thereof.

Accordingly, the remote controller 200 may know the exact positions of the master device 100 and the slave device 200.

When the remote controller 200 is already connected to the master device 100 and attempts Bluetooth pairing between the master device 100 and the slave device 300, the user needs to walk to the slave device 300, turn on the power of the slave device, and then enter a pairing mode using a conventional method. Similarly, in the master device 100, the user searches for a complicated menu, searches for the slave device 300 in a pairing menu, and selects the exact slave device 300 to perform pairing when the slave device 300 is found.

In the present disclosure, since the remote controller 200 knows the exact position of the slave device 300, when a specific key is input while the remote controller 200 is facing the slave device 300, the slave device 300 may be spontaneously turned on to enter a pairing mode. Here, the specific key may correspond to a pre-arranged key for easy pairing. To this end, the remote controller 200 may include the specific key as a physical key or output a virtual key through the display module of the master device 100. Similarly, when the remote controller 200 is a mobile device, the virtual key may be output through the display module of the mobile device.

To this end, the remote controller 200 may transmit and receive data as well as the position information of the master device 100 and the slave device 200 using UWB technology. Therefore, using the UWB technology, the remote controller 200 may prepare the slave device 300 to perform Bluetooth pairing, and the remote controller 200 may receive Bluetooth address information of the slave device 300. Thereafter, when the remote controller 200 transmits the Bluetooth address information of the slave device 300 to the master device 100 and transmits a pairing command, the master device 100 may automatically pair with the slave device 300.

In an embodiment of the present disclosure, the remote controller 200 may request setup for connection from the slave device 300, and may transmit information of the slave device 300 for connection to the master device 100. Accordingly, the master device 100 may perform Bluetooth pairing with the slave device 300.

To implement the system of FIG. 2, technology for improving the angle constraints of the master device is introduced in FIGS. 3A and 3B, and a process in which the remote controller initially establishes a UWB session with the master device and the slave device is introduced in FIG. 4.

FIGS. 3A and 3B are diagrams describing an embodiment in which the remote controller measures a position of a device according to an embodiment of the present disclosure. Hereinafter, a description overlapping with content described above will be omitted.

Referring to FIG. 3A, most master devices 100 are heavy home appliances, and thus are usually installed with backs thereof to the wall. In this case, the master device 100 may only detect slave devices located in a first area 400a within a 120-degree horizontal range in front.

It is preferable to use an antenna so that the master device 100 may detect all areas using UWB technology. However, since there is a limit to hardware that may be installed in the master device 100, only limited antennas may be used. Accordingly, a limited antenna is not a 360-degree surround system, and when the TV 100 is installed on a wall to face the front, the TV 100 cannot support 360-degree surround. For example, when the TV 100 is hung on the wall, there is a second area 400b where the TV 100 cannot structurally sense external devices even when using the UWB technology.

In an embodiment of the present disclosure, the second area 400b may sense an external device using the UWB technology in a direction of the remote controller 200. That is, the remote controller 200 may detect a slave device present in the first area 400a, reversely calculate position information, and transmit the position information to the TV 100.

Slave devices such as a sound bar and a Bluetooth speaker are usually used in a place outside a range of a UWB side of the TV 100 (for example, the second area 400b), and through an embodiment of the present disclosure, the remote controller 200 may measure exact positions of such slave devices and inform the TV 100 thereof.

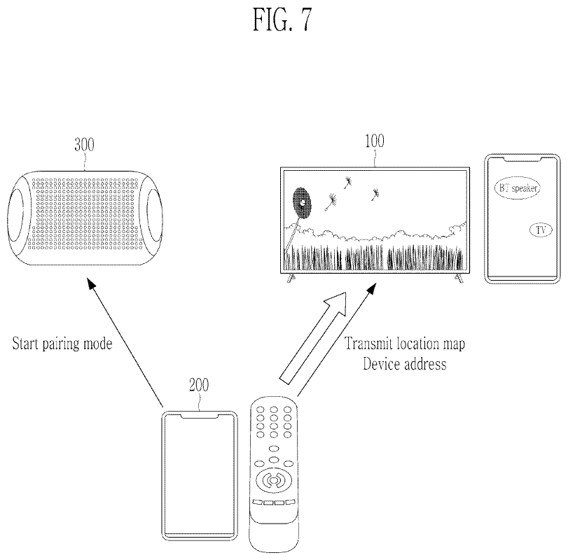

In this way, the TV 100 may automatically set L-R (left-right) of the slave device based on the position, and may automatically set the sound field effect according to the position. This will be described in detail in FIG. 7.

FIG. 3B illustrates an embodiment in which the remote controller 200 measures positions of the master device 100, a first slave device 300a, and a second slave device 300b.

More specifically, the remote controller 200 measures the positions of the master device 100, the first slave device 300a, and the second slave device 300b.

When the measured position information is transmitted to the master device 100, the master device 100 may calculate relative angles and distances of the first slave device 300a and the second slave device 300b with respect to the master device 100.

In an embodiment, the master device 100 may use law of sines triangulation.

More specifically, a distance a between the remote controller 200 and the first slave device 300a, a distance b between the remote controller 200 and the master device 100, and an angle C between the first slave device 300a and the master device 100 with respect to the remote controller 200 may be used to calculate a distance c between the master device 100 and the first slave device 300a and an angle A between the remote controller 200 and the first slave device 300a with respect to the master device 100.

That is, the distance c between the master device 100 and the first slave device 300a and the angle A between the remote controller 200 and the first slave device 300a with respect to the master device 100 may be used to determine a distance and position (left/right) of the first slave device 300a from the master device 100.

A method of measuring a distance and an angle from the master device 100 to the second slave device 300b is the same.

In this way, when the exact distance and direction of the slave devices 300a and 300b can be measured with respect to the master device 100, the TV 100, which is the master device 100, may use the surround system. The TV 100 may optimize the audio settings of the slave devices 300a and 300b by manipulating detailed parameters.

That is, in the past, when the slave devices 300a and 300b were sound bars or Bluetooth speakers, the TV 100 was manually set to use the respective slave device 300a and 300b as a left speaker, a right speaker, etc. However, according to an embodiment of the present disclosure, automatic setting is possible by positioning of the remote controller 200.

In addition, in an embodiment, the TV 100 may perform automatic setting of the volume according to the distance in addition to surround audio settings.

FIG. 4 is a diagram describing an embodiment in which the remote controller establishes a UWB session with a device according to an embodiment of the present disclosure. Hereinafter, a description overlapping with content described above will be omitted.

To perform the above-described embodiment and the embodiment described below, the remote controller 200 needs to previously establish a UWB session with the master device 100 and the slave device 300.

A method of establishing a UWB session between devices is not standardized, and thus varies depending on the manufacturer of the remote controller 200. However, since UWB technology is based on distance, a session may be established based on distance.

More specifically, in FIG. 4A, the remote controller 200 may approach the master device 100, and in FIG. 4B, the remote controller 200 may approach the slave device 300. Obviously, this indicates that the user brings the remote controller 200 to the master device 100 or the slave device 300.

In an embodiment, when the remote controller 200 approaches the master device 100 or the slave device 300 and then detects a signal representing pressing of a specific key, the remote controller 200 may establish a UWB session with the master device or the slave device 300.

In another embodiment, when the remote controller 200 approaches the master device 100 or the slave device 300 within a first range (for example, 5 mc), the remote controller 200 may establish a UWB session with the master device or the slave device 300.

When the remote controller 200 is a mobile device, the mobile device may output a modal dialog box including text such as “A UWB device has been detected nearby. Would you like to establish a UWB session?” through the display module. In this case, when a signal such as “Confirm” or “OK” is received from the user, a UWB session is established between the remote controller 200 and the UWB device (for example, the master device 100 or the slave device 300).

On the other hand, when the remote controller 200 does not have a display module similarly to a remote control, the remote control may approve the UWB session through a specific key of the remote control.

However, when the UWB session is not established, the remote controller 200 cannot measure the distance and angle with respect to the master device 100 and the slave device 300, and thus the remote controller 200 may first detect the master device 100 and the slave device 300 using a Bluetooth function.

To this end, the remote controller 200 may retrieve whether the master device 100 or the slave device 300 is within a proximity distance using the Bluetooth function. Here, the proximity distance may correspond to a proximity distance provided by the Bluetooth function included in the remote controller 200.

As described above, the remote controller 200 may detect the master device 100 or the slave device 300 using the Bluetooth function and create a UWB session through a Bluetooth gateway. In this instance, the remote controller 200 may receive information indicating whether the master device 100 or the slave device 300 is a device supporting UWB through Bluetooth advertising data.

That is, a distance, albeit inaccurate, may be measured using Bluetooth technology, and the remote controller 200 may identify a device supporting UWB technology using Bluetooth technology for the first time.

According to the above-described embodiment, when a UWB session is created, the remote controller 200 and the master device 100 or slave device 300 may provide each other with accurate distances and directions through the established UWB session.

FIG. 5A and FIG. 5B are diagrams describing an embodiment in which the master device pairs with the slave device using the remote control according to an embodiment of the present disclosure. Hereinafter, a description overlapping with content described above will be omitted.

In this instance, according to the above-described embodiment, it may be assumed that the remote controller 200 has previously established a UWB session with the master device 100 and the slave device 300.

In an embodiment, the master device 100 may receive information about the slave device 300 through the remote controller 200. Here, the information about the slave device 300 may include a Bluetooth address of the slave device 300.

Upon receiving a control signal (for example, an input signal for a specific key) from the remote controller 200, the master device 100 may perform Bluetooth pairing using the Bluetooth address of the slave device 300.

More specifically, referring to FIG. 5A, the remote controller 200 may receive a control signal representing long pressing of a specific key (for example, an “OK button” of the remote control) toward the slave device 300. Accordingly, the remote controller 200 may request that the slave device 300 turn on power via UWB communication.

When the slave device 300 is not paired with the master device 100, the remote controller 200 may request setup for Bluetooth pairing from the slave device 300 via UWB communication.

For example, when the slave device 300 is a Bluetooth speaker 300, the Bluetooth speaker 300 may support a sleep mode. Here, the sleep mode is a state where only a built-in core operates in a low-power mode, not a state where all parts are powered off. Therefore, external chips capable of receiving IR or other inputs may operate.

That is, a UWB module that performs UWB communication of the Bluetooth speaker 300 may operate in the sleep mode even when the power is turned off. Accordingly, the Bluetooth speaker 300 may receive a Bluetooth pairing setup request included in the UWB signal received from the remote controller 200.

Thereafter, when the remote controller 200 inputs a control signal for a specific key toward the Bluetooth speaker 300, the Bluetooth speaker 300 may be automatically turned on and perform Bluetooth pairing setup that may perform Bluetooth pairing with the master device 100. After the Bluetooth pairing setup of the Bluetooth speaker 300 is completed, the master device 100 may automatically perform Bluetooth pairing with the Bluetooth speaker 300.

In this instance, the remote controller 200 may transmit the Bluetooth address of the slave device 300 to the master device 100 through the UWB communication of the slave device 300. Accordingly, the master device 100 may perform Bluetooth pairing or connection with the slave device 300 based on the received Bluetooth address.

Unlike FIG. 5A, FIG. 5B illustrates an example in which the remote controller 200 is in close contact with the slave device 300. That is, the remote controller 200 and the slave device 300 use UWB communication, and thus may inform the master device 100 of exact distance and direction information with respect to the slave device 300.

Referring to FIG. 5B, when the remote controller 200 is brought into close proximity with the Bluetooth speaker 300, which is the slave device 300, within a first range (about 10 cm), the remote controller 200 may request that the Bluetooth speaker 300 turn on power through UWB communication.

In this instance, similar to FIG. 5A, when the Bluetooth speaker 300 and the master device 100 are not paired, the remote controller 200 may request that the Bluetooth speaker 300 set up Bluetooth pairing through UWB communication.

Thereafter, the remote controller 200 may transmit the Bluetooth address of the Bluetooth speaker 300 to the master device 100 through UWB communication. Thereafter, the master device 100 may attempt Bluetooth pairing with the Bluetooth speaker 300 or, when Bluetooth pairing has already been established, may immediately attempt connection based on the received Bluetooth address. That is, the embodiment of FIG. 5B is identical to the embodiment of FIG. 5A except that the remote controller 200 is placed in close contact with the Bluetooth speaker 300.

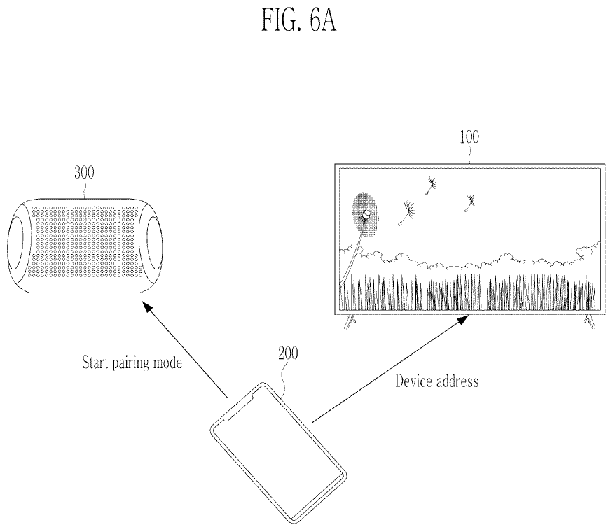

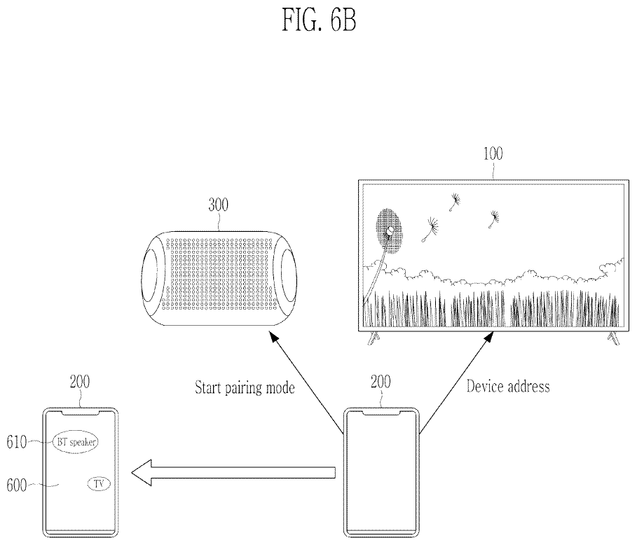

FIG. 6A and FIG. 6B are diagrams describing an embodiment in which the master device pairs with the slave device using the mobile device according to an embodiment of the present disclosure. Hereinafter, a description overlapping with content described above will be omitted.

In this instance, according to the above-described embodiment, it may be assumed that the remote controller 200 has previously established a UWB session with the master device 100 and the slave device 300.

However, the remote controller 200 described in FIGS. 6A and 6B is characterized by being a mobile device 200. Accordingly, since the mobile device 200 includes a display module, an embodiment different from that of FIGS. 5A and 5B may be utilized.

Referring to FIG. 6A, when the mobile device 200 faces or approaches the slave device 300, the mobile device 200 may output a modal dialog box inquiring as to whether to establish connection (whether to perform Bluetooth pairing). In this instance, an embodiment in which the mobile device 200 faces or approaches the slave device 300 is the same as the above-described embodiment.

In an embodiment, the mobile device 200 may receive input indicating whether consent is given from a user through a modal dialog box displayed on the display module. For example, the user may touch an “OK button”on the modal dialog box.

Accordingly, the mobile device 200 may transmit a power on request to the slave device 300 through UWB communication. In addition, when the slave device 300 and the master device 100 are not paired, the mobile device 200 may request that the slave device 300 start a Bluetooth pairing mode. In this instance, the mobile device 200 may simultaneously transmit the power on request and the Bluetooth pairing mode start request to the slave device 300 through UWB communication.

In addition, in an embodiment, the mobile device 200 may transmit the Bluetooth address of the slave device 300 to the master device 100. Accordingly, the master device 100 may request Bluetooth pairing from the slave device 300 based on the received Bluetooth address.

Referring to FIG. 6B, the mobile device 200 may output an icon corresponding to at least one device with which a UWB session has been established through the display module.

More specifically, the mobile device 200 may output an icon corresponding to at least one device on a location map 600. Here, the location map 600 corresponds to a map indicating relative positions of the master device 100 and the slave device 300. For example, when the master device 100 is the TV 100 and the slave device 300 is the Bluetooth speaker 300, the mobile device 200 may output the location map indicating the relative positions of the TV 100 and the Bluetooth speaker 300 on the display module.

In the embodiment of FIG. 6B, even though only the positions corresponding to the TV 100 and the Bluetooth speaker 300 are shown, it is obviously possible to express relative positions for all devices establishing a UWB session with the mobile device 200.

In an embodiment, in response to receiving a control signal representing selecting of an icon 610 corresponding to the Bluetooth speaker 300 included in the location map 600, the mobile device 200 may request Bluetooth pairing setup from the Bluetooth speaker 300 through UWB communication and transmit the Bluetooth address of the Bluetooth speaker 300 to the TV 100. That is, the following embodiments are the same as described above.

That is, the embodiments of FIGS. 6A and 6B may be useful when using the master device 100 that does not include a display module. More specifically, when the master device 100 includes the display module, Bluetooth pairing with the slave device 300 may be performed based on information output on the display module. On the other hand, in the case of the master device 100 not including a display module (for example, a refrigerator, a washing machine, etc.), there is no way to connect to another Bluetooth function providing device. Bluetooth pairing may be attempted through an application built into the master device 100. However, there is a problem in that the user cannot know what problem occurred when an error occurs.

On the other hand, in the embodiment of FIG. 6B, a device establishing a UWB session through the display module is output through the display module, and thus the user may easily select the slave device 300 and the master device 100 to visually perform Bluetooth pairing. In addition, when a problem occurs in Bluetooth pairing in the future, the problem may be easily solved through the display module of the mobile device 200.

FIG. 7 is a diagram describing an embodiment in which the master device controls the slave device according to an embodiment of the present disclosure. Hereinafter, a description overlapping with content described above will be omitted.

In this instance, according to the above-described embodiment, it may be assumed that the remote controller 200 has previously established a UWB session with the master device 100 and the slave device 300.

Referring to FIG. 7, the remote controller 200 may transmit information of the remote controller 200 and information of the slave device 300 to the master device 100 through UWB communication. In this instance, when the remote controller 200 is the mobile device 200 including the display module, the remote controller 200 may receive input of a device that desires Bluetooth pairing or connection among at least one device output to the location map through the display module. Other operations are the same as those in the above-described embodiment.

FIG. 7 describes an embodiment in which the master device 100 uses a surround sound mode by utilizing an embodiment of the present disclosure. To this end, the master device 100 may receive information about a location map of the remote controller.

In an embodiment of the present disclosure, after performing Bluetooth pairing with the slave device 300 through UWB communication, the master device 100 may automatically set the volume of the slave device 300 based on a relative distance and angle of the slave device 300.

More specifically, the master device 100 may receive and calculate a relative distance and angle between the slave device 300 and the master device 100 through the remote controller 200. Accordingly, the master device 100 may know in which direction and at what distance the slave device 300 is located with respect to the master device 100, and thus may automatically set the volume of the slave device 300.

For example, when there is a plurality of slave devices 300, the master device 100 may set the volume of each of the slave devices 300 based on distances and angles of a first slave device and a second slave device.

In addition, in an embodiment, the master device 100 may output a sound effect through the slave device 300 based on a relative distance and angle of the slave device 300.

That is, through UWB communication, the remote controller 200 may determine the exact locations and angles of the master device 100 and the slave device 300, and in this way, the master device 100 may complete a surround sound mode that provides surround sound.

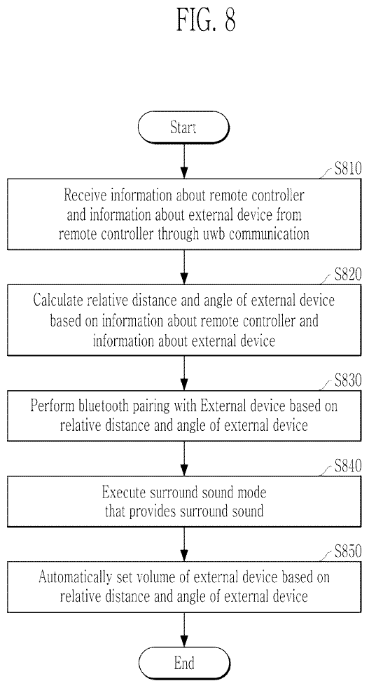

FIG. 8 is a diagram describing a method of controlling the TV according to an embodiment of the present disclosure. Hereinafter, a description overlapping with content described above will be omitted.

Referring to FIG. 8, in step (S810), the TV may receive information about the remote controller and information about the external device from the remote controller through UWB communication. Here, the information about the external device may include a Bluetooth address of the external device. In addition, the information about the external device may include a distance from the remote controller to the external device and an angle between the external device and the TV with respect to the remote controller.

In addition, in an embodiment, in order to create a UWB session for UWB communication with the remote controller, Bluetooth communication may be performed from the remote controller, and information indicating that the TV is a device supporting UWB communication may be transmitted through Bluetooth communication. In this instance, when the remote controller is a mobile device, the mobile device may be approved for creation of the UWB session through the display module. On the other hand, when the remote controller is a remote control, the remote control may be approved for creation of the UWB session through a specific key.

In step (S820), the TV may calculate a relative distance and angle of the external device based on the information about the remote controller and the information about the external device.

In step (S830), the TV may perform Bluetooth pairing with the external device based on the relative distance and angle of the external device. In an embodiment, the TV may perform Bluetooth pairing based on the received Bluetooth address.

In this instance, the remote controller may request, from the external device, at least one of power-on of the external device or setup for Bluetooth pairing through UWB communication.

In step (S840), the TV may execute a surround sound mode that provides surround sound.

In step (S850), the TV may automatically set the volume of the external device based on the relative distance and angle of the external device. In an embodiment, the TV may output a sound effect through the external device based on the relative distance and angle of the external device.

In addition, it is obvious that the embodiments described above through FIGS. 2 to 7 may be performed in sequential steps as in FIG. 8.

The present disclosure may be implemented as code that can be written to a computer-readable recording medium and can thus be read by a computer. The computer-readable recording medium may be any type of recording device in which data can be stored in a computer-readable manner. Examples of the computer-readable recording medium include a hard disk drive (HDD), a solid state drive (SSD), a silicon disk drive (SDD), a ROM, a RAM, a CD-ROM, a magnetic tape, a floppy disk, optical data storage, and a carrier wave (e.g., data transmission over the Internet). In addition, the computer may include the controller. The above exemplary embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein.

### INDUSTRIAL APPLICABILITY

The present disclosure may be repeatedly performed in a TV and a method of controlling the TV, and thus has industrial applicability.

1. A TV comprising:
a network interface unit configured to receive information about an external device through UWB communication from a remote controller, wherein the information about the external device includes a Bluetooth address of the external device and position information of the external device;
a display configured to output content; and
a controller configured to control the network interface unit and the display,
wherein the controller is configured to:
perform Bluetooth pairing with the external device based on the Bluetooth address of the external device;
calculate a relative distance and angle of the external device based on the position information of the external device, and
automatically set a volume of the external device based on the relative distance and angle of the external device.

2. The TV of claim 1, wherein the controller is configured to:
execute a surround sound mode providing surround sound.

3. The TV of claim 2, wherein the controller outputs a sound effect through the external device based on the relative distance and angle of the external device in the surround sound mode.

4. The TV of claim 1, wherein:
the controller executes the Bluetooth pairing based on the Bluetooth address in response to receiving a control signal from the remote controller.

5. The TV of claim 1, wherein the position information of the external device includes a distance from the remote controller to the external device and an angle between the external device and the TV with respect to the remote controller.

6. The TV of claim 1, wherein the controller is configured to:
perform Bluetooth communication from the remote controller to create a UWB session for the UWB communication with the remote controller, and
transmit information indicating that the TV is a device supporting the UWB communication through the Bluetooth communication.

7. The TV of claim 6, wherein, when the remote controller is a mobile device, the mobile device is approved for creation of the UWB session through a display module.

8. The TV of claim 6, wherein, when the remote controller is a remote control, the remote control is approved for creation of the UWB session through a specific key, and the specific key includes a physical key or a virtual key included in the remote controller.

9. The TV of claim 1, wherein the remote controller requests power-on of the external device through the UWB communication from the external device.

10. The TV of claim 9, wherein the remote controller requests setup for the Bluetooth pairing through the UWB communication from the external device.

11. A remote controller comprising:
a housing;
a UWB module configured to perform UWB communication, and
a controller,
wherein the controller is configured to:
calculate a distance to a master device and a distance to a slave device through the UWB communication,
calculate an angle between the master device and the slave device with respect to the remote controller, and
transmit the distances and the angle to the master device.

12. The remote controller of claim 11, further comprising at least one physical key included in the housing,
wherein, in response to receiving a control signal representing selecting of the physical key, the controller requests Bluetooth pairing setup from the slave device and transmits a Bluetooth address of the slave device to the master device.

13. The remote controller of claim 11, further comprising a display module,
wherein, when a distance to the slave device is less than or equal to a first distance or the remote controller is facing the slave device, the controller outputs a modal dialog box, and the modal dialog box includes information indicating whether Bluetooth pairing is performed between the master device and the slave device.

14. The remote controller of claim 13, wherein, in response to receiving a control signal representing selecting of a button included in the modal dialog box, the controller requests Bluetooth pairing setup from the slave device and transmits a Bluetooth address of the slave device to the master device.

15. The remote controller of claim 13, wherein the controller is configured to:
output a location map indicating a relative distance between the master device and the slave device through the display module, and
request Bluetooth pairing setup from the slave device and transmit a Bluetooth address of the slave device to the master device in response to receiving a control signal representing selecting of an icon corresponding to the slave device included in the location map.

16. A method of controlling a TV, the method comprising:
receiving information about an external device through UWB communication from the remote controller, wherein the information about the external device includes a Bluetooth address of the external device and position information of the external device;
performing Bluetooth pairing with the external device based on the Bluetooth address of the external device;
calculating a relative distance and angle of the external device based the position information of the external device;
executing a surround sound mode that provides surround sound; and
automatically setting volume of the external device based on the relative distance and angle of the external device.
